(19) United States
(12) Patent Application Publication
(10) Pub. No.: US 2010/0314333 A1
(43) Pub. Date: Dec. 16, 2010

(54) FLUTABLE FIBER WEBS WITH LOW SURFACE ELECTRICAL RESISTIVITY FOR FILTRATION

(75) Inventors: James M. Witsch, Saratoga Springs, NY (US); Christophe Lefaux, Cambridge, MA (US)

Correspondence Address: WOLF GREENFIELD & SACKS, P.C., 600 ATLANTIC AVENUE, BOSTON, MA, 02210-2206, US

(73) Assignee: Hollingsworth & Vose Company, East Walpole, MA (US)

(21) Appl. No.: 12/498,649

(22) Filed: Jul. 7, 2009

Related U.S. Application Data
(60) Provisional application No. 61/185,893, filed on Jun. 10, 2009.

(51) Int. Cl. B01D 39/08; D21H 11/00; D21H 13/10; D21H 13/24; D21H 13/26; D21H 13/12; D21H 17/33; D21H 17/63; B01D 37/00

(52) U.S. Cl. 210/767; 162/100; 162/157.1; 162/157.2; 162/157.3; 162/157.5; 162/164.1; 162/181.1; 210/505

(57) ABSTRACT

The fiber webs described herein may be incorporated into filter media and filter elements. The fiber webs may exhibit a low surface electrical resistivity. The fiber webs may also be sufficiently flexible and/or deformable so that they may be processed to include a series of waves (also known as flutes) that extend along the cross-machine direction.

### RELATED APPLICATIONS

This application claims priority to U.S. Provisional Patent Application Ser. No. 61/185,893, filed Jun. 10, 2009, which is incorporated herein by reference.

### FIELD OF INVENTION

The present invention relates generally to filtration and, more particularly, to flutable fiber webs that have a low surface electrical resistivity and can be used in filter elements.

### BACKGROUND OF INVENTION

Filter elements can be used to remove contamination in a variety of applications. Such elements can include a web of fibers. The fiber web provides a porous structure that permits fluid (e.g., gas, liquid) to flow through the element. Contaminant particles contained within the fluid may be trapped on the fiber web. Depending on the application, the fiber web may be designed to have different performance characteristics.

Fiber webs can be manufactured using conventional equipment. During manufacturing, fibers may be laid down in a continuous process to produce the web. This can lead to fiber alignment and the fiber web having a “machine direction” which is defined by the direction in which the web moves along the processing equipment, and a “cross-machine direction” which is perpendicular to the machine direction. Because of the fiber alignment, amongst other effects, properties of the fiber web along the machine direction can differ from properties along the cross-machine direction.

It may be advantageous to increase the effective surface area of the fiber web in some applications. For example, the fiber web may be waved to increase surface area. Such waves are generally referred to as corrugation, if they extend in the machine direction of the fiber web. The waves are called “flutes” if they extend in the cross-machine direction. The waved fiber webs can be combined with a backing layer to form channels through which fluid may flow. Some filter element configurations can take advantage of the channels and increased surface area provided by using fluted webs or by using corrugated webs. The machine direction and cross-machine direction properties of the web play an important role in its suitability for use in a particular configuration.

Triboelectrical charging on the fiber web surface can occur in some instances on fiber webs that do not dissipate electrical charge. The result can be a buildup of electrical charge on the fiber web itself. In environments in which the dust concentration is high enough and the dust is flammable, an electrical discharge could generate deflagration or, in a confined environment, an explosion. Examples of such environments can be in the following areas: coal handling, grain handling, pharmaceutical processing, and sugar refineries, amongst others. Therefore, it is desirable for filter elements used in such environments to be constructed in a manner that effectively dissipates electrical charge to prevent its accumulation.

### SUMMARY OF INVENTION

Flutable fiber webs that have a low surface electrical resistivity are described herein.

In one aspect, a fiber web is provided. The fiber web has a machine direction and a cross-machine direction. The fiber web includes a series of flutes that extend in the cross-machine direction, and the fiber web has a surface electrical resistivity of less than or equal to about 10¹¹ ohms/sq.

In one aspect, a fiber web is provided. The fiber web has a machine direction tensile elongation of greater than about 3%, a cross-machine direction tensile elongation of greater than about 5%, and a surface electrical resistivity of less than or equal to about 10¹¹ ohms/sq.

In one aspect, a method of manufacturing a fiber web is provided. The method includes forming a fiber mixture; forming a resin formulation; and adding the resin formulation to the fiber mixture to form a fiber web. The fiber web is capable of being fluted by including a series of flutes that extend in a cross-machine direction. The fiber web has a surface electrical resistivity of less than or equal to about 10¹¹ ohms/sq.

In one aspect, a method of filtering a fluid is provided. The method includes filtering a fluid using a filter element comprising a fiber web. The fiber web includes a series of flutes that extend in the cross-machine direction. The fiber web has a surface electrical resistivity of less than or equal to about 10¹¹ ohms/sq.

Other aspects, embodiments, advantages and features of the invention will become apparent from the following detailed description.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 depicts a fiber web with flutes that extend in the cross-machine direction to in accordance with some embodiments; and

FIG. 2 depicts a fluted fiber web that is laminated to a backing and wrapped into a spiral in accordance with some embodiments.

### DETAILED DESCRIPTION

The fiber webs described herein may be incorporated into filter media and filter elements. The fiber webs may exhibit a low surface electrical resistivity. This low surface electrical resistivity enables the webs to conduct and dissipate electric charge which otherwise might accumulate on surfaces of the webs and create potential hazardous conditions. The webs may also be sufficiently flexible and/or deformable so that they may be processed to include a series of waves (also known as flutes) that extend along the cross-machine direction of the webs without visibly cracking or splitting the webs. The flutes increase the effective surface area of the webs which can enhance filter performance. The flutes also provide web surface separation which can form channels within the resulting filter elements which allow for flow of fluid. For example, channels may be formed between a fluted fiber web and a backing applied to the web. As described further below, the fiber webs include various components (e.g., different fiber types, resin, and conductive material) which are selected and combined to impart the desired low surface electrical resistivity and mechanical properties. The webs may be incorporated into a variety of types of filter elements which are used in a number of applications including, in particular, those that are used in environments where static discharge may cause deflagration or explosions.

The fiber webs are formed of one or more types of fibers and a resin formulation to provide mechanical and chemical properties. As described further below, a resin formulation may comprise several components including a resin, a crosslinking agent and a conductive material, amongst other additives. However, in some embodiments, the conductive material or other additives may be provided to the fiber web separately from the resin formulation.

In some cases, fiber(s) may be the principal component of the fiber web. That is, in these cases, the total fiber weight percentage may be greater than the weight percentage of any other component in the web. For example, the fiber component(s) may comprise between about 50% and about 95% of the total weight of the fiber web. In some embodiments, the fibers make up between about 70% and about 80% (e.g., 75%) by weight of the fiber web. The resin formulation may comprise the remainder of the fiber web that is not the fiber component(s) in certain embodiments. In some embodiments, the resin formulation comprises between about 5% and about 50% of the total weight of the fiber web. In some embodiments, the resin formulation includes between about 20% and about 30% (e.g., 25%) by weight of the fiber web.

It should be understood that in some embodiments the fiber web may include fiber component(s) and/or resin formulations outside the above-noted ranges.

In general, the fiber component(s) of the fiber web may be formed of any suitable composition. Suitable compositions include cellulose, synthetic materials, and glass. As described further below, it may be preferable to use a blend of different fiber compositions; though, in other cases, a single fiber composition may be used.

Suitable cellulose fiber compositions include softwood fibers, hardwood fibers and combinations thereof. Examples of softwood cellulose fibers include fibers that are derived from the wood of pine, cedar, alpine fir, douglas fir, and spruce trees. Examples of hardwood cellulose fibers include fibers derived from the wood of eucalyptus (e.g., Grandis), maple, birch, and other deciduous trees.

Suitable synthetic fibers include fibers formed from polyaramid, polypropylene, polyethylene, polyamide, polyether ether ketone, polyester (e.g., PET), lyocell, rayon, and combinations thereof. It should be understood that other types of synthetic fibers may also be used.

Suitable glass fibers may include chopped strand glass fibers or microglass fibers.

As noted above, the fiber web may include more than one type of fiber. For example, in some embodiments, the fiber web may include a blend of cellulose fibers and synthetic fibers. In some of these embodiments, the cellulose fibers may be the principal fiber type. That is, the weight percentage of cellulose fiber may be greater than the weight percentage of synthetic fiber. In some embodiments, the fiber web may include between about 50 and about 95 weight percent cellulose fiber. In some embodiments, the fiber web may include between about 15 and about 30 weight percent (e.g., between 20 and 25 weight percent) synthetic fiber and between about 35 and about 65 weight percent (e.g., between 50 and 55 weight percent) cellulose fiber. In some of these embodiments, the cellulose fiber within the web may comprise both softwood and hardwood fibers. For example, the fiber web may include between about 20 and about 40 weight percent (e.g., between 30 and 35 weight percent) softwood and between about 15 and about 25 weight percent (e.g., between 20 and 22.5 weight percent) hardwood. It should be understood that some embodiments may include fiber compositions and weight percentages outside the above-noted ranges. For example, in some embodiments, the principal fiber type may be synthetic fibers, e.g., between about 50% and about 95% of the total weight of the fiber web may be synthetic fibers. In some embodiments, all of the fiber in the web may be synthetic. In other embodiments, all of the fiber in the web may be cellulose fiber.

In general, when present, the synthetic fibers may have any suitable dimensions. In some embodiments, the average diameter of the fibers are less than 25 microns. For example, the average fiber diameter may be between about 3 microns and about 20 microns; and, in some cases, between about 5 microns and about 10 microns. In some embodiments, the aspect ratio of the fibers range between about 1000 and about 7000; and, in some cases, between about 1100 and about 1500.

In general, the cellulose fibers, when present, may have any suitable dimensions. In some embodiments, the average diameter of the fibers are less than about 50 microns. For example, the average fiber diameter may be between about 5 microns and about 50 microns. Softwood cellulose may generally be between about 30 and about 40 microns. Hardwood cellulose may generally be between about 10 and about 20 microns. In some embodiments, the aspect ratio of the cellulose fibers range between about 80 and about 600; and in some cases, between about 200 and about 600 for the hardwood cellulose fibers and between about 150 and about 300 for softwood cellulose fibers.

In addition to the fiber component(s), the fiber web includes an appropriate resin formulation. As noted above, the resin formulation can include a number of different components such as a resin, a crosslinking agent, and the conductive material, amongst other additives.

The resin is generally the principal component of the resin formulation. That is, the resin is generally the largest component by weight of the resin formulation. In some cases, the fiber web may include between about 5 and about 50 weight percent (e.g., between 15 and 30 weight percent) resin.

In general, any suitable resin may be used. Examples of suitable resins include to styrene acrylic, acrylic, poly ethylene vinyl chloride, styrene butadiene rubber, polystyrene acrylate, polyacrylates, polyethylene vinyl chloride, polyvinyl chloride, polynitriles, polyvinyl acetate, polyvinyl alcohol derivatives, starch polymers, and combinations thereof. It should be understood that other resin compositions may also be suitable. In some embodiments, the resin may exhibit a glass transition temperature ranging between about 10° C. and about 50° C., or between about 25° C. and about 30° C. In some cases, the resin may be in a latex form, such as a water-based emulsion.

The resin may exhibit self-crosslinking or non-crosslinking behavior. For example, a self-crosslinking resin may include monomers (e.g., N-methylolacrylamide, or other crosslinking groups) in the backbone that exhibit crosslinking behavior. If the resin material is not self-crosslinking, then an appropriate crosslinking agent may be added to the resin material. The weight percentage of the crosslinking agent based on the total weight of the resin formulation (when dry) can be less than about 20 weight percent; and, in some cases, between about 1 and about 5 weight percent. The fiber web may include less than about 1 weight percent of the crosslinking agent. Examples of suitable crosslinking agents include melamine formaldehyde, alkylated melamine formaldehyde, N-alkyl melamine, DMDHEU, epoxy, aziridine, and/or combinations thereof.

In some cases, the fiber web may exhibit a cure ratio of between about 0.05 and about 1.0, or between about 0.80 and about 1.0. As used herein, the cure ratio is the ratio of a wet property of the web prior to curing (e.g., cross-machine wet tensile or wet Mullen burst tests of the fiber web before cure) to a wet property post-curing (e.g., cross-machine wet tensile or wet Mullen burst tests of the fiber web after cure).

It should be appreciated that other crosslinking agents and/or weight percentages may also be suitable.

The resin formulation may also include a conductive material component. This component is particularly important for imparting the desired low surface electrical resistivity properties to the fiber web. In general, the conductive material component is present in an amount sufficient to impart the desired surface electrical resistivity. For example, the fiber web may include between about 0.5 and about 10 weight percent of the conductive material component. In some cases, the fiber web may include between about 1 and about 5 weight percent (e.g., between 1.5 and 3 weight percent) of the conductive material component. The weight percentage of the conductive material component based on the total weight of the resin formulation (when dry) can be between about 5 and about 50 weight percent; and, in some cases, between about 10 and about 25 weight percent (e.g., 18 weight percent).

As noted above, the conductive material component may be present as a separate component from the resin formulation in some embodiments.

Examples of suitable conductive materials that may be incorporated in the fiber web include graphite, carbon black, metals (e.g., aluminum, iron, copper), conductive polymers and/or resins (e.g., derivatives of polyacetylene, polyaniline, Polypyrrole, Poly(phenylene vinylene), poly(3-alkylthiophenes), amongst others), doped materials (e.g., phosphorus-doped, boron-doped), and conductive salts. It should be understood that other conductive materials may also be suitable.

The conductive material may be present in a variety of forms. Suitable forms include particles, nanotubes (e.g., carbon nanotubes), fibers or coatings. The particular form may depend on the composition of the conductive material. For example, carbon black is generally present in particle form. In some cases, when the conductive material is in the form of particles, the particle size may be less than about 1 micron.

The conductive material may be incorporated in the fiber web along with the resin formulation or in a separate process. For example, when the conductive material is in the form of a coating, it may be formed using a sputtering process. The sputtering process, for example, may be done as a secondary process after the fiber web is formed.

The fiber webs may also include other conventional additives that may be added to impart desirable characteristics. For example, to impart antimicrobial and/or antifungal properties, the webs may include suitable antimicrobial and/or antifungal agents such as silver or silver-based compounds, copper or copper-based compounds, diiodomethyl-p-tolysolfone, methyl peracept, 5-chloro-2-(2,4-dichlorophenoxy)phenol, triclosan, pyrithion derivates, halogenated phenoxy compounds, and zinc 2-pyridinethiol-1-oxide, amongst others. In some embodiments, the fiber web may include a flame retardant agent such as antimony trioxide, decabromodiphenyl ether, halogenated polymers, halogenated compounds, phosphorous-based compounds (e.g., diammonium phosphate), aluminum-based compounds, nitrogen-based compounds, magnesium sulfate, and guanidine, amongst others.

The fiber webs may be incorporated into a filter media. The filter media may include a single fiber web or more than one fiber web having different characteristic. The filter media may also include other components in addition to the fiber web(s), such as a backing, a laminated scrim, and/or additional additives as described above.

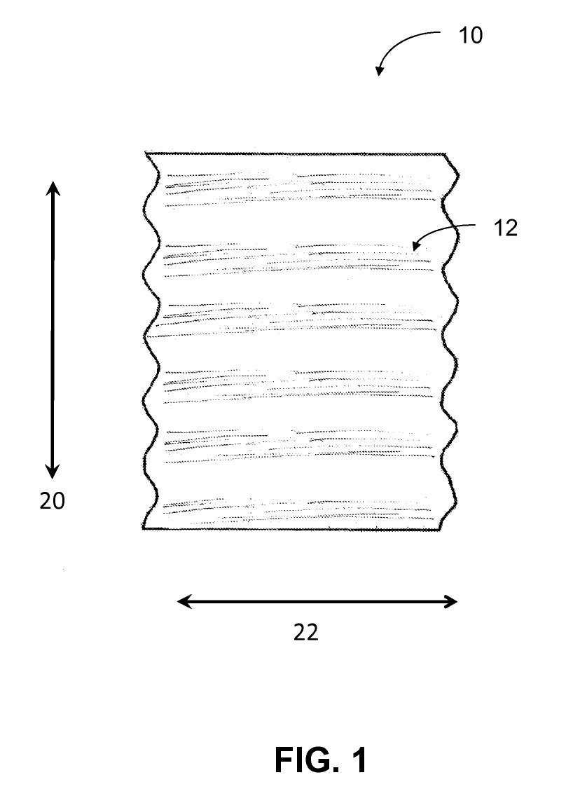

As noted above, the fiber webs described herein can include a series of flutes. The flutes, for example, may be in the form of a sinusoidal pattern of waves. In certain preferred embodiments, the flutes extend in the cross-machine direction as shown in FIG. 1. As shown, fiber web 10 has a machine direction 20 and a cross-machine direction 22. The fiber web 10 has flutes 12 having peaks and valleys where the flutes run parallel to the cross-machine direction 22. As noted above, the cross-machine direction 22 is perpendicular to the machine direction 20 and the machine direction 20 is defined by the direction in which the fiber web moves along the processing equipment. However, it should be understood that not all embodiments are limited to flutes that extend in the cross-machine direction. When a fiber web is considered to be flutable, the fiber web may undergo a fluting process such that no visible cracking or splitting of the fiber web occurs.

The flutes of the fiber web may be within a range of frequencies and amplitudes. For example, the frequency of flutes may range between about 1 flute/inch and about 20 flutes/inch, or between about 4 flutes/inch and about 8 flutes/inch. The amplitude of the flutes may range between about 1 mil and about 100 mils, or between about 10 mils and about 45 mils. As used herein, the amplitude is defined as the distance between the top of a peak and bottom of a valley. In general, in a given fiber web, the flutes generally have a similar amplitude and similar frequency across the web, though that is not a requirement. It should also be understood that flute frequencies and amplitudes outside the above-noted ranges are possible.

The fiber webs described herein may exhibit a low surface electrical resistivity which enables the web to conduct and dissipate electric charge. Surface electrical resistivity, as measured herein, is in units of ohms/sq. Surface electrical resistivity can be measured according to the standard ANSI/ECP-STM11.11 for measuring surface electrical resistance of static dissipative planar materials. Surface electrical resistivity can be measured using a concentric ring measuring probe such as the Trek Model 152P-CR-E available from Trek, Inc. (www.trekinc.com).

In some embodiments, the surface electrical resistivity of the fiber web may be less than or equal to about 10¹¹ ohms/sq. In some embodiments, the surface electrical resistivity is less than or equal to about 10⁹ ohms/sq, less than or equal to about 10⁸ ohms/sq (e.g., between 10⁴ ohms/sq and 10⁸ ohms/sq), or less than or equal to about 10⁷ ohms/sq. In some embodiments, the surface electrical resistivity may be less than or equal to about 10⁴ ohms/sq, less than or equal to about 10³ ohms/sq; and in some cases, the surface electrical resistivity may approach zero.

In some embodiments, it may be preferable for the fiber web to be sufficiently flexible and/or deformable to facilitate formation of the fluted structure described above. The flexibility and deformability can be characterized by a number of mechanical properties including Mullen burst tests and tensile tests.

In general, the Mullen burst tests measure the pressure required for puncturing a fiber web as an indicator of the load carrying capacity of the fiber web under specified conditions. Mullen burst may be measured for the fiber web in both dry and wet conditions. In some embodiments, the dry Mullen burst for the fiber web may be greater than about 35 psi (e.g., between 35 psi and about 100 psi); and, in some embodiments, the dry Mullen burst may be greater than about 38 psi. Additionally, the wet Mullen burst may be greater than about 10 psi (e.g., between about 10 psi and 200 psi); and, in some embodiments, the wet Mullen burst may be between about 30 psi and about 50 psi. Mullen burst tests are measured following the Technical Association of the Pulp and Paper Industry (TAPPI) Standard T 403 om-91, “Bursting strength of paper”.

The fiber web may have different tensile properties in the machine direction as compared to the cross-machine direction. In some embodiments, the tensile elongation values in the machine direction may be less than that in the cross-machine direction, while the tensile strength values in the machine direction may be greater than that in the cross-machine direction. For example, the machine direction tensile elongation of the fiber web may be greater than about 3% (e.g., between about 3% and 6%); and, in some embodiments, greater than about 4%. The cross-machine direction tensile elongation of the fiber web may be greater than about 5% (e.g., between 5% and 10%); and, in some embodiments, greater than about 6%. The machine direction tensile strength of the fiber web may be greater than about 15 lb/in (e.g., between about 15 lb/in and 100 lb/in, or between about 20 lb/in and 40 lb/in). The cross-machine direction tensile strength of the fiber web may be greater than about 5 lb/in (e.g., between about 5 lb/in and about 30 lb/in, or between about 10 lb/in and about 20 lb/in). In some cases, the cross machine direction tensile strength may be greater than the machine direction tensile strength. The ratio between the machine direction tensile strength and cross machine direction tensile strength may range between about 1 and about 3, or between about 1.5 and about 2.8. Tensile tests are measured following TAPPI Standard T 494 om-88, “Tensile breaking properties of paper and paperboard (using constant rate of elongation apparatus).”

In some embodiments, the machine direction wet Gurley stiffness of the fiber web may be measured to be between about 100 mg and about 1000 mg, or between about 150 mg and about 300 mg. Gurley stiffness tests are measured following TAPPI Standard test 543, “Bending stiffness of paper.”

In some embodiments, the Schopper burst height for the fiber web may be measured to be greater than about 2.5 mm (e.g., between about 2.5 mm and about 2.7 mm) Schopper burst heights are measured according to (DIN EN) ISO Procedure 2758, “Paper—burst strength—Mullen.”

In general, the fiber web may have any suitable basis weight. For example, the basis weight of the fiber web may range from between about 30 g/m² and about 165 g/m², or between about 60 g/m² and about 100 g/m². The basis weight of the fiber web is measured according to TAPPI Standard T 410 om-93.

In general, the fiber web may have any suitable thickness. Suitable thicknesses include, but are not limited to, between about 5 mils and about 30 mils (e.g., between about 9 mils and about 14 mils). The fiber web thickness is determined according to TAPPI T 411 om-89, “Thickness (caliper) of paper, paperboard, and combined board” using an electronic caliper microgauge 3.3 Model 200-A manufactured by Emveco, www.emveco.com, and tested at 1.5 psi.

The fiber web may have a range of permeability. For example, the permeability of the fiber web may range from between about 5 cubic feet per minute per square foot (cfm/sf) and about 200 cfm/sf, or between about 15 cfm/sf and about 30 cfm/sf. The permeability of the fiber web is measured according to TAPPI Method T251. The permeability of a fiber web is an inverse function of flow resistance and can be measured with a Frazier Permeability Tester. The Frazier Permeability Tester measures the volume of air per unit of time that passes through a unit area of sample at a fixed to differential pressure across the sample. Permeability may be expressed in cubic feet per minute per square foot at a 0.5 inch water differential.

In some embodiments, the mean flow pore size of the fiber web may range, for example, between about 5 microns and about 50 microns, or between about 15 microns and about 20 microns. Mean flow pore size is measured using ASTM Standard F 316, “Pore size characteristics of membrane filters by bubble point.” The fiber web can also be characterized by Palas filtration performance. Such testing is based on the following parameters: filter area of the fiber web is 100.0 cm²; face velocity is 20.0 cm/sec; dust mass concentration is 200.0 mg/m³; dust/aerosol is SAE fine; total volume flow is about 120.0 L/min, and no discharge. Palas filtration performance is generally measured according to ISO Procedure 5011:2000, “Inlet air cleaning equipment for internal combustion engines and compressors—performance testing.”

The initial fractional efficiency may be characterized using Palas filtration tests. In some embodiments, the initial fractional efficiency of the fiber web for particles approximately 0.3 microns in size may be between about 50% and about 99%, or between about 70% and about 90%. In some embodiments, the initial fractional efficiency (efficiency at a given particle size) of the fiber web for particles approximately 1.0 micron in size may be between about 90% and about 99%, or between about 95% and about 99%. It can be appreciated that the larger the particle size, the more likely the particles will be captured.

The initial dust retention may also be characterized using Palas filtration tests. In some embodiments, the initial dust retention (efficiency for all particles in the dust) of the fiber web may range between about 50% and about 99%, or between about 85% and about 95%.

The initial pressure drop may also be characterized using Palas filtration tests. In some embodiments, the initial pressure drop may range between about 50 Pascal and about 500 Pascal, or between about 250 Pascal and about 350 Pascal.

It should be understood that, in some embodiments, the fiber web may have property values outside one or more of the above-noted ranges.

In general, the fiber web may be processed using conventional techniques and equipment. For example, in some embodiments, a wet laid process may be used to form the fiber web. Suitable techniques can involve forming the resin formulation and a fiber mixture in separate processes, followed by a suitable step (e.g., coating or impregnation) which combines the two. The specific process depends, in part, on the particular components being used. Those of ordinary skill in the art know suitable parameters and equipment for such processing. The following paragraphs include an exemplary description of a process suitable for producing a fiber web that includes synthetic and cellulose fiber components.

The fiber web formation process can involve blending synthetic and cellulose fibers together to form a fiber mixture comprising a pulped fiber blend. In some embodiments, the cellulose fibers are first added to a pulper with water and stirred until the fibers are suitably dispersed. Water is then added to the fiber dispersion for dilution to a desired consistency (e.g., about 0.05% to about 6%). Synthetic fibers (e.g., polyester) may then be added to the dispersion of cellulose fibers followed by additional dilution with water to reach the desired consistency (e.g., about 0.05% to about 6%).

The dispersion of synthetic and cellulose fibers are continually mixed and then subsequently formed into a fiber web using a suitable sheet forming equipment such as a delta former, an inclined wire, a fourdrinier, or a rotoformer.

The fiber web is then dried using appropriate methods which may utilize ultrasonic or microwave techniques, steam cans, infrared heaters (gas and/or electric), or air ovens. Typical drying times may be between about 5 seconds and about 10 minutes and drying temperatures may range between about 100° F. and about 500° F.

As noted above, the resin formulation can be prepared in a separate process from the fiber web. For example, the components of the resin formulation including the resin, the crosslinking agent (if present) and conductive material are mixed in a mixer and diluted with water to an appropriate solids level (e.g., between about 1% and about 50% solids). Solids level is defined as the percentage of solids in a liquid media whether in a solution or a dispersion. In general, the mixture should be relatively uniform and continuous.

The resin formulation mixture is then added to the dried fiber web. For example, the resin formulation mixture may be provided as a coating on the fiber web. Examples of suitable coating methods include curtain coating, gravure coating, knife coating, size press coating, spray coating, and/or any other suitable method of coating.

The web and resin formulation mixture is then dried and cured at appropriate conditions (e.g., times between about 0.1 seconds and about 10 minutes, and temperatures between 100° F. and about 500° F.). In addition, the temperature for drying and curing the resin coating with the fiber web may range between about 100° F. and about 500° F. Once the resin and the fiber web are suitably dried and cured, the fiber web may be further processed as desired, for example, to form flutes.

The flutes may be formed in the fiber web by passing the fiber web through male/female corrugation rolls with defined fluting patterns. In some embodiments, flutes may be formed through deformation and shape setting through cooling and crosslinking of the fiber web. In some cases, the fluted fiber web may be laminated to another flat media for holding the flutes in place. In some instances, fluting is performed in situ while the resin has not yet fully cured, allowing for flutes to form through the curing process. In some embodiments, fluting occurs as a secondary process after the sheet is constructed and cured. In some embodiments, the fiber web may be heated during fluting. For example, temperatures during fluting of the fiber web may range between about 70° F. and about 100° F.

The fiber webs described herein may be incorporated into a number of suitable filter media and filter elements. It should be understood that the filter media and filter elements may have a variety of different constructions with the particular construction depending on the application in which the filter media and elements are used. For example, a backing may be applied to a fluted fiber web to form a filter media that includes a series of channels between the backing and the web. The assembly may be wrapped to form a spiral arrangement as described further below. In some embodiments, the channels may be alternately sealed. This configuration allows fluid (e.g., air) to enter through an open channel with the seal(s) directing the fluid through the web and into an adjacent channel through which it travels and exits the media. In this respect, fluid including contaminants travels in and is filtered through the web. The channels may be layered, providing the filter element with a tight, rugged structure. In some embodiments, the filter media may be spirally and/or radially wound around a central core.

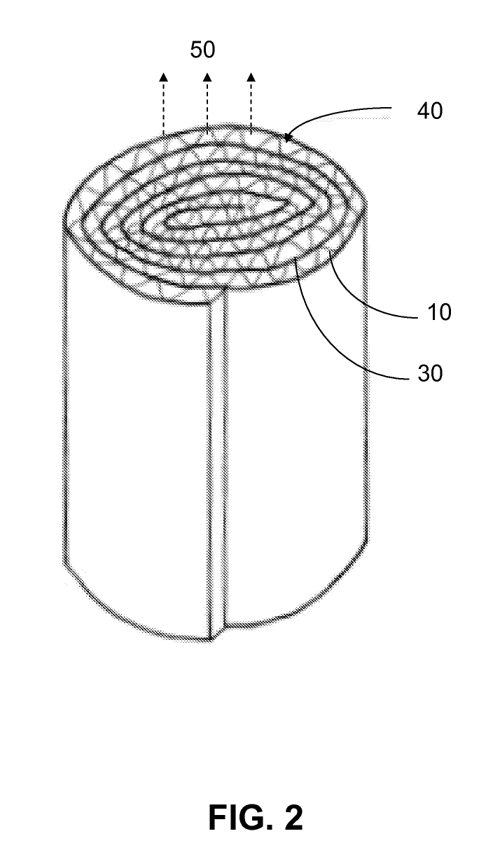

FIG. 2 illustrates an embodiment of a filter media that includes a fluted fiber web 10 that is laminated to a generally flat backing 30 to form channels 40. The media is in a spiral arrangement. In this embodiment, the machine direction of the web is in the direction in which the web is wound to form the spiral. As shown, fluid is able to readily flow through the channels. As noted above, alternate channels may include seal(s) which direct the fluid into adjacent channels, thus, filtering the fluid. The fluid may exit the channels in a direction depicted by the dotted lines 50. In some embodiments, the arrangement depicted in FIG. 2 may be incorporated into a filter element by addition of a housing.

In addition, fluted fiber webs presented herein may be incorporated into filter elements for panel, radial, and conical fluid applications. In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rounded or oval configuration surrounding the element. The frame may be formed from various materials, including for example, cardboard, metal, polymers, plastic, or any combination of suitable materials. In some embodiments, the filter element includes an inner core around which the filter media comprising the fiber web is wrapped. Filter media that is radially disposed around an inner core, for example, in a cylindrical or conical manner, may be suitably supported by a surrounding frame. The filter elements may also include a variety of other features known in the art, such as stabilizing features for stabilizing the filter media relative to the frame, spacers, or any other appropriate feature.

The fiber webs described herein may be incorporated into a number of suitable filter elements for use in various applications which make use of their fluted and/or the electrical dissipative characteristics. In particular, the fiber webs may be generally used for filter applications that have use for low surface electrical resistivity such as applications that expose the filter elements to electrical charge during use. In this regard, the fiber webs are able to adequately dissipate electrostatic charge that would otherwise be susceptible to accumulation. In addition, the fiber webs may be used in applications that take advantage of their toughness and flexibility which result in a resistance to brittle cracking or failure. Applications that typically use fiber webs in a fluted construction include the construction, agriculture, mining, trucking, and automotive industries. Examples of filter elements that the fiber webs may be incorporated into include, but are not limited to, radial air filter elements, conical air elements, dust collector cartridges, turbine oil filters, and fuel filters, amongst others.

The following non-limiting examples describe fiber webs suitable for flutable static dissipative applications that have been made according to aspects discussed herein.

### Example

A flutable fiber web was produced according to techniques described above. The web included softwood fibers (Robur Flash NCB, Northern softwood—spruce), eucalyptus (Grandis) fibers, and synthetic fibers (Barnet P05HT 1.5d×0.25 inch PET fibers) which comprised 75% by weight of the finished fiber web The resin formulation, which comprised 25% by weight of the finished fiber web included a polyethylene vinyl fluoride latex, melamine formaldehyde and carbon black. The finished fiber web included 31.5% by weight softwood fibers, 21% by weight eucalyptus fibers, 22.5% by weight synthetic fibers, 22.25% by weight latex, 0.5% by weight melamine formaldehyde, and 2.25% by weight carbon black. The web had a 26 mil depth, a 5.8 cycle/inch pattern, and was flutable without visible cracking or splitting of the web. Table 1 below provides a summary of the characteristics measured. The sample was both flutable and static dissipative.

TABLE 1

| Physical Property | Value |
|---|---|
| Dry Mullen (psi) | 43.8 |
| Schopper Burst (kPa) | 238 |
| Burst Height (mm) | 2.6 |
| Dry Tensile MD (lb/in) | 29.4 |
| Dry Elongation MD (%) | 4.7 |
| Dry Tensile CD (lb/in) | 14.7 |
| Dry Elongation CD (%) | 7.9 |
| Resin Tg ° C. | 30 |
| Surface Electrical Resistivity (ohm/sq) | 5.3 × 10⁷ |
| Static Dissipative | Yes |
| Flutable | Yes |

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A fiber web having a machine direction and a cross-machine direction, the fiber web including a series of flutes that extend in the cross-machine direction, the fiber web having a surface electrical resistivity of less than or equal to about 10¹¹ ohms/sq.

2. The fiber web of claim 1, wherein the fiber web has a surface electrical resistivity of less than or equal to about 10⁹ ohms/sq.

3. The fiber web of claim 1, wherein the fiber web has a surface electrical resistivity of less than or equal to about 10⁷ ohms/sq.

4. The fiber web of claim 1, wherein the frequency of the flutes is between about 1 flute/inch and about 20 flutes/inch.

5. The fiber web of claim 1, wherein the amplitude of the flutes is between about 1 mil and about 100 mils.

6. The fiber web of claim 1, wherein the fiber web includes cellulose fibers.

7. The fiber web of claim 1, wherein the fiber web includes synthetic fibers.

8. The fiber web of claim 7, wherein the synthetic fibers comprise at least one of the materials selected from the group consisting of polyaramid, polypropylene, polyethylene, polyamide, polyether ether ketone, polyester, lyocell, rayon, and PET.

9. The fiber web of claim 1, wherein the fiber web includes cellulose and synthetic fibers.

10. The fiber web of claim 1, wherein the fiber web includes a resin formulation.

11. The fiber web of claim 10, wherein the resin formulation comprises between about 10% and about 50% by weight of the fiber web.

12. The fiber web of claim 1, wherein the fiber web comprises a conductive material component.

13. The fiber web of claim 12, wherein the conductive material component is part of the resin formulation.

14. The fiber web of claim 12, wherein the conductive material component comprises at least one component selected from the group consisting of graphite, carbon black, metals, conductive polymers and/or resins, doped materials and conductive salts.

15. The fiber web of claim 1, wherein the fiber web includes a dry Mullen burst of greater than about 35 psi.

16. The fiber web of claim 1, wherein the fiber web includes a wet Mullen burst of greater than about 10 psi.

17. The fiber web of claim 1, wherein the fiber web has a tensile elongation in the machine direction of greater than about 3%.

18. The fiber web of claim 1, wherein the fiber web has a permeability of between about 5 cfm/sf and about 200 cfm/sf.

19. The fiber web of claim 1, wherein the fiber web has a thickness of between about 5 mils and about 30 mils.

20. The fiber web of claim 1, wherein the fiber web has a basis weight of between about 30 g/m² and about 165 g/m².

21. The fiber web of claim 1, wherein the fiber web has a mean pore size of between about 5 microns and about 50 microns.

22. A filter element comprising the fiber web of claim 1.

23. A fiber web having a machine direction tensile elongation of greater than about 3%, a cross-machine direction tensile elongation of greater than about 5%, and a surface electrical resistivity of less than or equal to about 10¹¹ ohms/sq.

24. The fiber web of claim 23, wherein the fiber web has a dry Mullen burst of greater than about 35 psi.

25. The fiber web of claim 23, wherein the fiber web has a Schopper burst height of greater than about 2.5 mm.

26. The fiber web of claim 23, wherein the fiber web has a thickness of between about 5 mils and about 30 mils.

27. A filter element comprising the fiber web of 23.

28. A method of manufacturing a fiber web, the method comprising:
forming a fiber mixture;
forming a resin formulation;
adding the resin formulation to the fiber mixture to form a fiber web that is capable of being fluted by including a series of flutes that extend in a cross-machine direction, wherein the fiber web has a surface electrical resistivity of less than or equal to about 10¹¹ ohms/sq.

29. A method of filtering a fluid, the method comprising:
filtering a fluid using a filter element comprising a fiber web, the fiber web including a series of flutes that extend in the cross-machine direction, and the fiber web having a surface electrical resistivity of less than or equal to about 10¹¹ ohms/sq.
